(19) United States
(12) Patent Application Publication
(10) Pub. No.: US 2005/0262056 A1
(43) Pub. Date: Nov. 24, 2005

(54) Method and system for searching source code of computer programs using parse trees

(75) Inventors: Mark Joseph Hamzy, Round Rock, TX (US); Dustin C. Kirkland, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/850,388

(22) Filed: May 20, 2004

(51) Int. Cl. G06F 7/00

(52) U.S. Cl. 707/3

(57) ABSTRACT

A method and system for searching source code of computer programs using parse trees are provided. With the method and system, a search query is provided in terms of the utility desired from source code meeting the search query. For example, a series of functions or operations to be performed by source code, that are indicative of the source code that is desired to be found by a user, may be entered as a search query. The search query is converted to one or more parse trees which are then compared against parse trees of source code maintained by the source code search engine database. Parse trees that have nodes matching the parse tree(s) of the search query are identified and a ranking of the extent of the matching between the parse trees is generated. Ranked search results are then returned identifying the source code that matches the search query.

### BACKGROUND OF THE INVENTION

1. Technical Field

The present invention is generally directed to an improved data processing system. More specifically, the present invention is directed to a method and system for searching source code of computer programs using parse trees.

2. Description of Related Art

Search engines are software that searches for content on the Internet or network that corresponds to a particular search query. Such searches typically include identifying indexes of web sites and web pages, in a database of web site/web page indexes, which have keywords that match the terms entered in the search query. Although a search engine is the actual software and algorithms used to perform a search, the term has become synonymous with the Web site itself. For example, Google™ is a major search site on the Internet, but rather than being called the “Google™ web site,” it is commonly known as the “Google™ search engine.”

Known search engines are limited to performing pure text comparison searches. That is, the search engine merely identifies those indices that include words matching those terms entered in the search query. As a result, while the known search engines may be extremely useful for locating desired web sites and web pages, their limitations do not lend themselves to other applications, such as searching for particular portions of source code of computer programs.

It is often desirable for a computer programmer to locate already existing computer programs or portions of computer programs that solve a particular problem or have a particular sequence of operations. For example, if a programmer wishes to calculate a Fibonacci sequence, rather than taking the time to determine how to generate a program to perform this operation, the programmer may choose to locate a computer method or routine that is already in existence that performs this operation.

Using a traditional text search engine, the programmer may enter keywords such as “Fibonacci” and “program” in an attempt to identify source code that calculates a Fibonacci sequence. As a result, the programmer may receive a large number of results which discuss the Fibonacci sequence, mathematical approaches to generating the Fibonacci sequence, historical information, and the like, none of which provides source code to actually generate the Fibonacci sequence. In other words, the search engine will return results that identify web sites and web pages that describe the Fibonacci sequence, but do not necessarily provide a solution to the programmer's problem.

If source code is made available on the Internet and specifically includes the words “Fibonacci” and “program” in it, then the source code may be returned in the search results of such a query. This is because source code is not treated any differently than regular text in web sites and web pages by traditional search engines. However, if the source code does not include these terms, then it will not be returned as a result of the search, even though the source code may actually solve the problem the programmer wishes to solve using the entered search query.

This limitation of traditional search engines is especially problematic when the source code being search for does not have a generally accepted name, such as “Fibonacci”, and can only be described in terms of the operations that need to be performed. In such a case, the programmer will typically have to be resigned to generating the code themselves unless they known the precise textual syntax (variable names as well) of the source code that they are seeking. This often defeats the purpose when the user is in fact trying to learn exactly how to accomplish some task.

With the overwhelming success and proliferation of open source projects, such as the Linux™ operating system project and GNU™ tools, increasing amounts of source code are made available on the Internet every day. Thus, it would be beneficial to provide a search engine that permits more efficient and user friendly searching of this source code.

### SUMMARY OF THE INVENTION

The present invention provides a method and system for searching source code of computer programs using parse trees. With the method and system, a search query is provided in terms of the utility desired from source code meeting the search query. For example, a series of functions or operations to be performed by source code, that are indicative of the source code that is desired to be found by a user, may be entered as a search query.

The search query is converted to one or more parse trees which are then compared against parse trees of source code maintained by the source code search engine database. Parse trees that have nodes matching the parse tree(s) of the search query are identified and a ranking of the extent of the matching between the parse trees is generated. Ranked search results are then returned identifying the source code that matches the search query.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing system in which aspects of the present invention may be implemented;

FIG. 2 is an exemplary diagram of a server computing system in which aspects of the present invention may be implemented;

FIG. 3 is an exemplary diagram of a client computing system in which aspects of the present invention may be implemented;

FIG. 4 is an exemplary diagram illustrating the interaction of the primary operational components according to one exemplary embodiment of the present invention;

FIG. 5 is an exemplary diagram of a graphical user interface through which a source code search query may be input for searching source code in one or more source code database in accordance with one exemplary embodiment of the present invention;

FIG. 6 is an exemplary diagram illustrating the generation of a parse tree from source code in accordance with one exemplary embodiment of the present invention;

FIG. 7 is an exemplary diagram illustrating a comparison of a parse tree of a source code search query with a partially matching parse tree of source code in a source code database in accordance with one exemplary embodiment; and

FIG. 8 is a flowchart outlining an exemplary operation of the present invention when performing a source code search in accordance with one exemplary embodiment of the present invention.

### DETAILED DESCRIPTION OF THE PREFERRED EMBODIMENTS

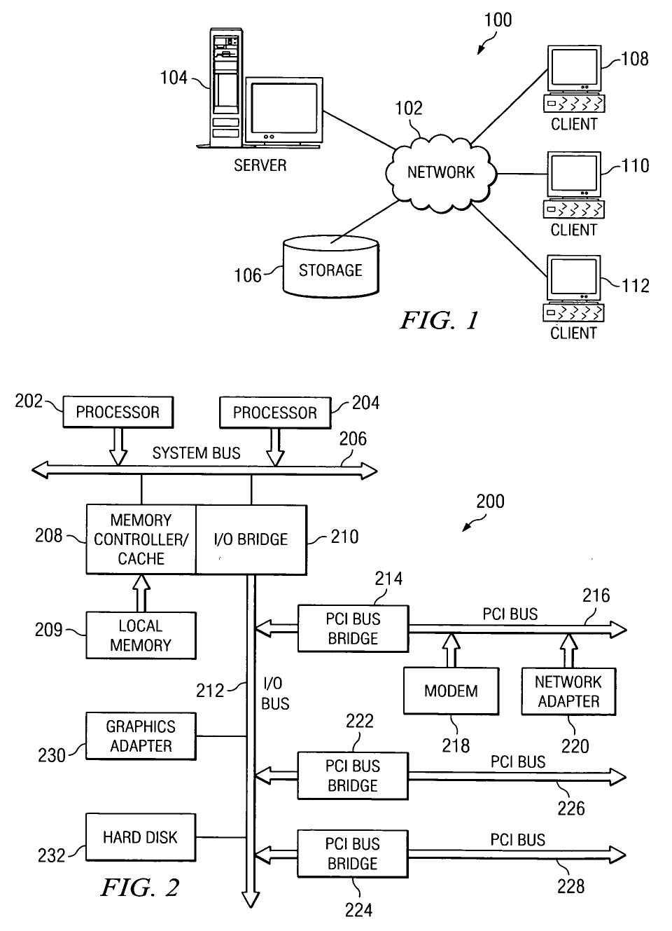

The present invention is directed to a mechanism for searching source code. The present invention is preferably used for searching source code in a distributed data processing environment, such as the Internet, a wide area network (WAN), local area network (LAN), or the like, but is not limited to such and may be used in a stand-alone computing system or completely within a single computing device. The following FIG. 1-3 are intended to provide a context for the description of the mechanisms and operations performed by the present invention. The systems and computing environments described with reference to FIG. 1-3 are intended to only be exemplary and are not intended to assert or imply any limitation with regard to the types of computing system and environments in which the present invention may be implemented.

With reference now to the figures, FIG. 1 depicts a pictorial representation of a network of data processing. systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between majorsnodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

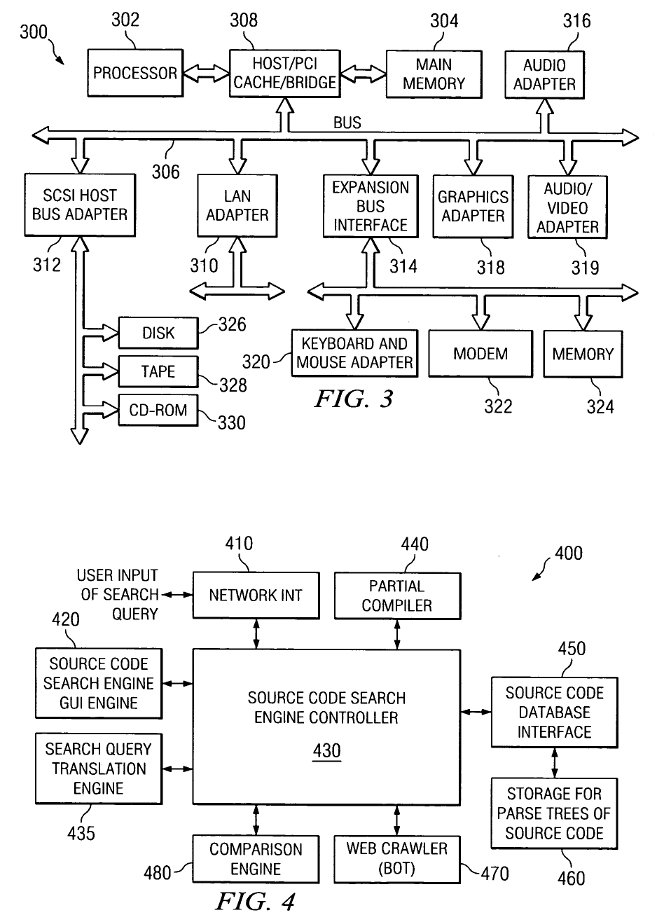

With reference now to FIG. 3, a block diagram illustrating a data processing system is depicted in which the present invention may be implemented. Data processing system 300 is an example of a client computer or stand-alone computing device in which the aspects of the present invention may be implemented. Data processing system 300 employs a peripheral component interconnect (PCI) local bus architecture. Although the depicted example employs a PCI bus, other bus architectures such as Accelerated Graphics. Port (AGP) and Industry Standard Architecture (ISA) may be used. Processor 302 and main memory 304 are connected to PCI local bus 306 through PCI bridge 308. PCI bridge 308 also may include an integrated memory. controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned above, the present invention provides a mechanism for performing searches of source code for computer programs using parse trees. The parse trees provide a representation of the utility or functionality of the source code, e.g., the series of operations performed by the source code, and are not limited to the particular variable names or other text that may be present in the source code. Thus, the present invention provides a mechanism for searching source code based on what the source code accomplishes and not just on the particular terms that are used in the source code.

With the method and system of the present invention, a search query is provided in terms of the utility desired from source code meeting the search query. For example, a series of functions or operations to be performed by source code, that are indicative of the source code that is desired to be found by a user, may be entered as a search query. The search query is converted to one or more parse trees which are then compared against parse trees of source code maintained by the source code search engine database. Parse trees that have nodes matching the parse tree(s) of the search query are identified and a ranking of the extent of the matching between the parse trees is generated. Ranked search results are then returned identifying the source code that matches the search query. In this manner, the present invention provides a utility based search engine for searching source code.

FIG. 4 is an exemplary diagram illustrating the interaction of the primary operational components according to one exemplary embodiment of the present invention. As shown in FIG. 4, the prlmary operational components of the depicted embodiment of the present invention includes a network interface 410, a source code search engine graphical user interface (GUI) engine 420, a source code search engine controller 430, a source code search query translation engine 435, a partial compiler 440, a source code database interface 450, a storage for parse trees of source code 460, a web crawler (or bot) 470, and a comparison engine 480. These components may be implemented in software, hardware or any combination of software and hardware without departing from the spirit and scope of the present invention. In a preferred embodiment, the components depicted in FIG. 4 are implemented as software instructions that are executed by one or more data processing devices, such as, for example, the server illustrated in FIG. 2.

With the present invention, a user of a client device may access the source code search engine provided by the source code search system 400 via one or more networks, such as network 102. In response to an access request from a client device via the network, the source code search engine GUI engine 420 of the source code search system 400 provides a GUI through which the user of the client device may enter a source code search query.

The source code search query entered by the user of the client device, in accordance with a preferred embodiment, takes the form of a description of the utility or functionality for which the user wishes to locate source code. This description may be, for example, a series of function descriptions that matching source code would perform.

Assume that a user of a client device wishes to locate a block of source code, a subroutine, or a very specific subset of code that implements the Fibonacci algorithm for calculating Fibonacci numbers, a well known sequence of numbers that describes many natural phenomena. In the Fibonacci algorithm, the value of a Fibonacci number is the sum of the two numbers immediately preceding it in the sequence. Thus, the primary operations performed by an algorithm that calculates the Fibonacci number sequence may be summarized as follows:
var4 set to sum of var2 and var3
var2 set to var3
var3 set to var4

The above description of the operations performed by source code that would calculate the Fibonacci number sequence may be input by a user of a client device using the source code search engine GUI engine 420. It should be noted that the variable names “var2,” “var3,” and “var4” are only place holders and do not limit the searching capabilities of the source code search engine of the present invention. To the contrary, the above description is interpreted by the source code search engine of the present invention as any source code that sets a first variable to the sum of a second variable and a third variable, and then sets the value of the second variable to the value of the third variable and the value of the third variable to the value of the sum. The actual variable names are irrelevant to the source code searching of the present invention and emphasis is provided to the actual functions or operations performed.

When the user enters a source code search query, such as the example shown above, and presses a virtual send button in the source code search query GUI, the source code search query is transmitted to the source code search engine controller 430 via one or more networks and the network interface 410. The search engine controller 430 provides the source code search query to the search query translation engine 435 which translates the source code search query to a parse tree representation. The search query translation engine 435 may make use of similar translation techniques that are used by the partial compiler 440 to convert source code to a parse tree representation. The search query translation engine 435, however, does not operate on source code but instead operates on the description of the utility or functionality entered as a source code search query.

A parse tree, as the term is used in the present description, is an interpreted representation of software source code whereby implementation specific arbitrary programmatic or stylistic choices are abstracted (such as variable names and particular syntax requirements of various languages). This concept of a “parse tree” may be implemented in any one of many different ways. For the sake of clarity and conciseness of the present description, a pseudo-code parse tree representation of a Perl source code program will be used for descriptive purposes only.

The source code search query parse tree representation that is generated by the search query translation engine 435 is then used to search a database of source code parse trees 460 for any source code parse trees that have a matching or even partially matching portion of code. While a single source code parse tree databases 460 is illustrated, in actuality there may be many different source code parse tree databases 460 that are searchable by the present invention. For example, separate source code parse tree databases 460 may be maintained for various types of open source projects such as the Linux™ operating system, GNU™ tools, and the like.

The entries in the source code parse tree database 460 are generated by locating source code that is made available over one or more networks, or is otherwise accessible to the source code searching system 400, and partially interpreting the source code using the partial compiler 440. The source code may be identified using the web crawler or bot 470 which goes to various network addresses and analyzes the content associated with the network addresses to determine if source code is made available through that network address. If so, the source code may be retrieved via the network interface 410 and processed by the partial compiler 440. The partial compiler 440 attempts to interpret the retrieved source code to a point at which a parse tree of the source code is generated. This parse tree is then stored in the source code parse tree database 460 for later use in source code searches.

Upon receiving a source code search query and converting the source code search query to a parse tree representation, entries from the source code parse tree database 460 are retrieved and compared to the parse tree representation of the source code search query using comparison engine 480. If there is at least a partial match between the source code parse tree from database 460 and the parse tree representation of the source code search query, then the corresponding source code file, subroutine, method, algorithm, etc., is stored in a search result data structure that is provided to the source code search engine controller 430. As each source code parse tree is compared to the parse tree representation of the source code search query, if there is a partial match between them, the source code filename, method, etc. is added to the search results data structure.

Once all the source code parse tree entries in the database 460 are searched, when a predetermined number of results have been retrieved, or when the search has been operating for a predetermined period of time, the search results data structure is processed by the source code search engine controller 430 to place the search results in a ranked order. The particular order is dependent upon the particular implementation, however, in a preferred embodiment, the ranking is done such that the source code entries in the source code parse tree database 460 that most closely match the source code search query are ranked at the top of the search results. The ranked search results are then returned to the client device via the network interface 410.

Subsequently, the search results are output in a search results portion of the source code search engine GUI for use by a user of the client device. If the user of the client device then selects an entry in the search results, the browser on the client device may be redirected to the computing device or environment from which the source code associated with the entry in the search results may be obtained.

Thus, the present invention provides a mechanism for searching source code that performs such searching based on parse trees of the source code and of a source code search query entered by a user of a client device. Because the present invention makes use of parse trees rather than pure text matching, the present invention may identify source code that performs the same operations, functions, or accomplishes the same task as the one described in the source code search query even though the same variable names, text, and the like are not utilized.

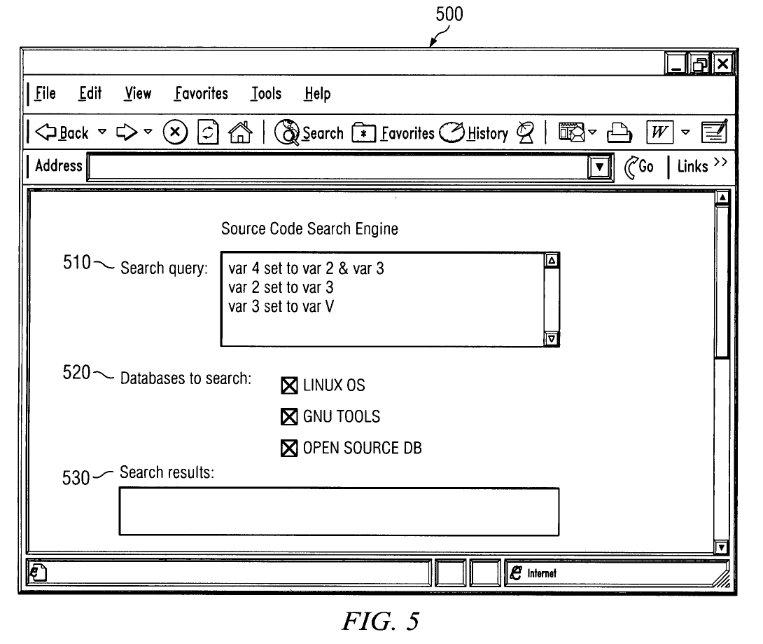

FIG. 5 is an exemplary diagram of a graphical user interface (GUI) through which a source code search query may be input for searching source code in one or more source code databases in accordance with one exemplary embodiment of the present invention. As shown in FIG. 5, the GUI 500 includes a first GUI element 510 through which a source code search query may be entered. The first GUI element 510 preferably takes the form of a text input field or box in which one or more lines of source code operation or function description may be entered.

This description text is used to generate the source code search query that is transmitted to the source code search system 400. That is, each line of the search query text entered into first GUI element 510 is parsed to generate a parse tree for that line. The parse trees for the lines may then be combined using known Boolean operations, such as AND, NOT, OR, and the like, regular expression operation, such as zero or more occurrences, one or more occurrences, parentheses to group elements, and the like. The result is a single parse tree that represents all of the lines entered into first GUI element 510.

A second GUI element 520 is provided for designating which source code parse tree databases are to be searched using the source code search query entered in the first GUI element 510. A designation of the selected databases may be provided along with the source code search query to the source code search system 400 and the source code search engine controller 430 will then initiate a search on only those source code parse tree databases identified in the received source code search query.

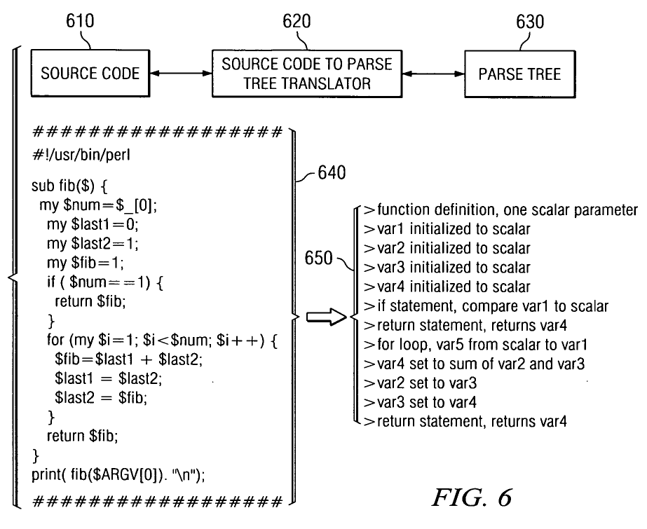

FIG. 6 is an exemplary diagram illustrating the generation of a parse tree from source code in accordance with one exemplary embodiment of the present invention. As shown in FIG. 6, source code 610 is obtained, for example, by using the web crawler 470 or the like, and is provided to a source code to parse tree translator 620. The source code to parse tree translator 620 may be part of the partial compiler 440, for example, and performs the function of parsing the source code and generating parse tree elements based on the identified functions, attributes, etc. that are encountered during the parsing of the source code. The generation of parse trees from source code is generally known in the art as being a substep in the process of a compiler compiling source code into executable code. The result of this translation is an abstract parse tree 630 that is a compact representation of the meaning of the source code 610, e.g., the functions/operations performed by the source code 610.

Also shown in FIG. 6 are actual examples of source code 640 and a corresponding parse tree idealized representation 650 that may be generated by the source code to parse tree translator 620 in accordance with the present invention. The parse tree idealized representation 650 may be stored in a source code parse tree database for later use in source code searching as previously described above.

The steps taken to convert the source code 640 into the parse tree idealized representation 650 are to read the ASCII source code file one character at a time, convert the characters into tokens, look at the tokens and find grammar rules that match the tokens and convert the grammar rules, as applied to the tokens, into a parse tree. For the code shown in FIG. 6, parsing the ASCII source code file and converting the characters into tokens results in the following list of tokens:

| token | character(s) |
|---|---|
| comment | # |
| text | ################################ |
| whitespace | |
| comment | # |
| text | !/usr/bin/perl |
| whitespace | |
| SUB keyword | sub |
| function name | fib |
| LEFT PAREN keyword | ( |
| argument list | $ |
| RIGHT PAREN keyword | ) |
| whitespace | |
| LEFT CURLY BRACE | { |
| keyword | |
| whitespace | |
| MY keyword | my |
| variable name | $num |
| whitespace | |
| EQUALS keyword | = |
| whitespace | |
| variable name | $_[0] |
| SEMICOLON keyword | ; |
| whitespace | |
| MY keyword | my |
| variable name | $last1 |
| whitespace | |
| EQUALS keyword | = |
| whitespace | |
| integer | 0 |
| SEMICOLON keyword | ; |
| whitespace | |
| MY keyword | my |
| variable name | $last2 |
| whitespace | |
| EQUALS keyword | = |
| whitespace | |
| integer | 1 |
| SEMICOLON keyword | ; |
| whitespace | |
| MY keyword | my |
| variable name | $fib |
| whitespace | |
| EQUALS keyword | = |
| whitespace | |
| integer | 1 |
| SEMICOLON keyword | ; |
| whitespace | |
| IF keyword | if |
| whitespace | |
| LEFT PAREN keyword | ( |
| whitespace | |
| variable name | $num |
| whitespace | |
| EQUALS EQUALS keyword | == |
| whitespace | |
| integer | 1 |
| whitespace | |
| RIGHT PAREN keyword | ) |
| whitespace | |
| LEFT CURLY BRACE | { |
| keyword | |
| whitespace | |
| RETURN keyword | return |
| whitespace | |
| variable name | $fib |
| SEMICOLON keyword | ; |
| whitespace | |
| RIGHT CURLY BRACE | } |
| keyword | |
| whitespace | |
| FOR keyword | for |
| whitespace | |
| LEFT PAREN keyword | ( |
| whitespace | |
| MY keyword | my |
| whitespace | |
| variable name | $i |
| EQUALS keyword | = |
| integer | 1 |
| SEMICOLON keyword | ; |
| whitespace | |
| variable name | $i |
| whitespace | |
| LESSTHAN keyword | = |
| variable name | $num |
| SEMICOLON keyword | ; |
| whitespace | |
| variable name | $i |
| PLUS PLUS keyword | ++ |
| RIGHT PAREN keyword | ) |
| whitespace | |
| LEFT CURLY BRACE | { |
| keyword | |
| whitespace | |
| variable name | $fib |
| whitespace | |
| EQUALS keyword | = |
| whitespace | |
| variable name | $last1 |
| whitespace | |
| PLUS keyword | + |
| whitespace | |
| variable name | $last2 |
| SEMICOLON keyword | ; |
| whitespace | |
| variable name | $last1 |
| whitespace | |
| EQUALS keyword | = |
| whitespace | |
| variable name | $last2 |
| SEMICOLON keyword | ; |
| whitespace | |
| variable name | $last2 |
| whitespace | |
| EQUALS keyword | = |
| whitespace | |
| variable name | $fib |
| SEMICOLON keyword | ; |
| whitespace | |
| RIGHT CURLY BRACE | } |
| keyword | |
| whitespace | |
| RETURN keyword | return |
| whitespace | |
| variable name | $fib |
| SEMICOLON keyword | ; |
| whitespace | |
| RIGHT CURLY BRACE | } |
| keyword | |
| whitespace | |
| PRINT keyword | |
| LEFT PAREN keyword | ( |
| whitespace | |
| function name | fib |
| LEFT PAREN keyword | ( |
| variable name | $ARGV |
| LEFT BRACKET keyword | [ |
| integer | 0 |
| RIGHT BRACKET keyword | ] |
| RIGHT PAREN keyword | ) |
| whitespace | |
| DOT keyword | . |
| whitespace | |
| DOUBLE QUOTE keyword | “ |
| text | \n |
| DOUBLE QUOTE keyword | “ |
| whitespace | |
| RIGHT PAREN keyword | ) |
| SEMICOLON keyword | ; |
| whitespace | |
| comment | # |
| text | ################################ |
| whitespace | |
| end-of-file | |

For simply programming languages, these tokens are examined one at a time to identify grammar rules that match the tokens. For more complex programming languages, a look-ahead buffer may be employed to implement the process. The grammar rules are then used to convert the tokens into a parse tree idealized representation 650. This same process may be applied to the source code search query entered by the user to search for source code. That is, the source code search query may be regarded as the ASCII file that is to be parsed. Obviously, the parse tree of the source code search query will be much smaller than the parse tree of the source code ASCII file.

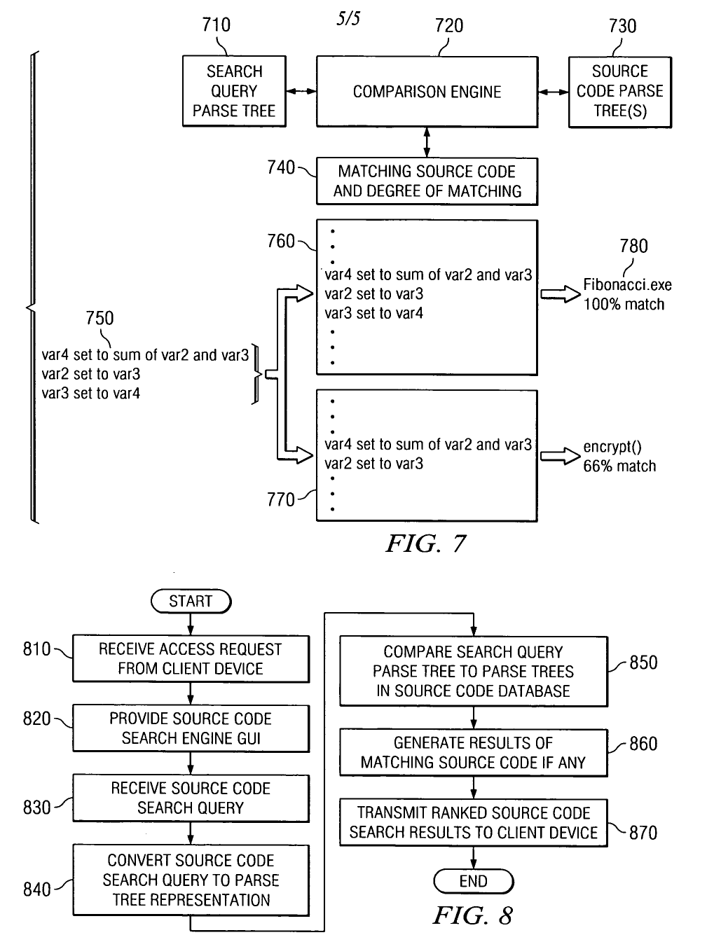

FIG. 7 is an exemplary diagram illustrating a comparison of a parse tree of a source code search query with a partially matching parse tree of source code in a source code database in accordance with one exemplary embodiment. As shown in FIG. 7, a search query parse tree 710 is provided to the comparison engine 720 which also receives parse trees 730 of source code from the source code parse tree database(s). The comparison engine 720 compares elements of the search query parse tree 710 against elements in the parse trees of the source code 730 to determine a degree of matching. For those source code parse trees that have greater than a minimum degree of matching, the corresponding filename, method, subroutine, etc. is identified in the search results 740 along with the degree of matching. These search results may then be ranked according to the corresponding degree of matching so that an ordered list of matching source code is provided to the user of the client device that submitted the search query.

In one exemplary embodiment of the present invention, matching of the parse tree of the source code search query 710 and the parse trees of the source code 730 is performed using regular expressions. The following is a simple example of such a comparison for the source code search query “$i=1.”

First, a set of tokens is generated for the source code search query:

| variable name | $i |
|---|---|
| EQUALS keyword | = |
| integer | 1 |

This set of tokens is then matched to grammar rules to generate a parse tree representation of the source code search query. A regular expression is then generated based on the parse tree:

<VARIABLE NAME: i>(<WHITESPACE> *)?<EQUALS

KEYWORD>(<WHITESPACE> *)?<INTEGER:1>

This regular expression states: find a variable name that is “i,” followed by an optional one or more white spaces, followed by an “=”, followed by an optional one or more white spaces, followed by an integer “1”. This regular expression may be compared against similar regular expressions generated for source code that are generated in a similar manner. Full and partial matches may be identified and provided as search results.

This example may be extrapolated to situations in which the actual variable name and parameter values are not matched but the functions performed are the basis for the matching, as previously described above. For example, in a slightly more complex search query, a search of source code may be performed for any variable that is set to the sum of two other variables.

As an example of the comparison performed by the present invention, assume that the search query parse tree 710 takes the form shown in element 750. When comparing this parse tree to the parse trees of source code 730, two portions of source code parse trees 760 and 770 are determined to provide some partial match to the search query parse tree. Source code parse tree 760 is determined to be a 100% match in that the same exact series of functions/operations described in the search query parse tree 750 are found in the source code parse tree 760. The source code parse tree 770 is determined to be a 66% match since only two of the lines of the search query parse tree are found in the source code parse tree 770. Thus, the search results 780 will be ordered such that the filename associated with the source code parse tree 760 is presented first in the list with an associated degree of matching equal to 100% and the filename associated with the source code parse tree 770 is presented second in the list with an associated degree of matching equal to 66%.

FIG. 8 is a flowchart outlining an exemplary operation of the present invention when performing a source code search in accordance with one exemplary embodiment of the present invention. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 8, the operation starts by receiving an access request from a client device (step 810). In response, a source code search engine GUI is provided to the client device (step 820). Thereafter, a source code search query may be received from the client device via the provided GUI (step 830).

The source code search query is then converted to a parse tree representation of the search query (step 840) and is compared against parse trees for source code maintained in a source code parse tree database (step 850). As previously mentioned above, the actual searching may encompass a plurality of databases and is not limited to just one. In addition, the particular databases to be searched may be identified by the search query received from the client device.

Results are then generated based on a determination as to which source code parse trees contain matching portions to the search query parse tree (step 860). The results may then be ranked and ordered such that a particular organization of the search results is obtained. For example, in a preferred embodiment, the search results are ranked based on a degree of matching between the source code parse tree and search query parse tree. The ranked search results may then be ordered such that the greatest matching source code parse tree entry is provided at the top of the search results list. The ranked and ordered search results may then be transmitted to the client device for the user's review and optional selection (step 870).

Thus the present invention provides an improved mechanism for searching source code made available by one or more computing systems. One of the key features of the present invention is the use of parse trees to facilitate the searching of source code. Search queries are converted to parse trees and are used to search parse trees that have been generated for source code. In this way, the underlying functionality and tasks accomplished by the source code are searched rather than merely performing a direct text matching as in known search engines. Thus, with the present invention, source code that accomplishes the same task or performs the same series of functions/operations may be identified despite the specific text utilized by this source code.

In addition to the above, the present invention permits source code using various different programming languages to be searched using the source code search engine of the present invention. As long as the source code may be represented as a parse tree in a common accepted parse tree language, then it does not matter which programming language is used to actually write the source code. The partial compiler of the present invention may contain the portions of compilers for various programming languages that are used to generate parse trees and thus, may perform a partial compilation of source code from various computer programming languages. These partial compilations will result in a common parse tree representation that may then be matched against the search query parse tree.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system, for searching for source code matching search criteria, comprising:
receiving, from a computing device, a source code search query identifying source code search criteria;
converting the source code search criteria to a parse tree representation;
retrieving one or more source code parse trees from a source code parse tree storage;
comparing the source code search criteria parse tree representation to the one or more source code parse trees;
generating search results based on the comparison of the source code search criteria parse tree representation to the one or more source code parse trees; and
transmitting the search results to the computing device.

2. The method of claim 1, wherein the source code search criteria sets forth a functional description of a portion of source code that is desired to be found in the source code of one or more computer programs, wherein the functional description is independent of at least one of variable names and parameter values.

3. The method of claim 1, wherein the source code search criteria parse tree and the source code parse trees are independent of variable names.

4. The method of claim 1, wherein converting the source code search criteria to a parse tree representation includes:
using a partial compiler to interpret the source code search criteria.

5. The method of claim 1, wherein converting the source code search criteria to a parse tree representation includes:
parsing the source code search criteria to identify tokens within the source code search criteria; and
matching the identified tokens with grammar rules to generate the source code search criteria parse tree representation.

6. The method of claim 1, wherein comparing the source code search criteria parse tree representation to the one or more source code parse trees includes:
comparing nodes in the source code search criteria parse tree representation to nodes in the one or more source code parse trees;
determining if there is a match between at least a portion of the nodes in the source code search criteria parse tree representation and a portion of the nodes in the one or more source code parse trees.

7. The method of claim 6, wherein comparing the source code search criteria parse tree representation to the one or more source code parse trees further includes:
determining a degree of matching of nodes in the source code search criteria parse tree representation and the nodes in the one or more source code parse trees.

8. The method of claim 7, wherein generating search results based on the comparison of the source code search criteria parse tree representation to the one or more source code parse trees includes:
ranking source code parse trees that have at least a portion of their nodes matching at least a portion of the nodes in the source code search criteria parse tree representation, based on a determined degree of matching of the source code parse trees.

9. The method of claim 1, wherein the one or more source code parse trees are generated by:
identifying source code to be converted to a source code parse tree;
parsing the source code to identify tokens within the source code;
identifying grammar rules applicable to the identified tokens; and
generating a source code parse tree based on the identified grammar rules as applied to the identified tokens.

10. The method of claim 9, wherein identifying source code to be converted to a source code parse tree includes using a web crawler that searches for source code available on a network.

11. A computer program product in a computer readable medium for searching for source code matching search criteria, comprising:
first instructions for receiving, from a computing device, a source code search query identifying source code search criteria;
second instructions for converting the source code search criteria to a parse tree representation;
third instructions for retrieving one or more source code parse trees from a source code parse tree storage;
fourth instructions for comparing the source code search criteria parse tree representation to the one or more source code parse trees;
fifth instructions for generating search results based on the comparison of the source code search criteria parse tree representation to the one or more source code parse trees; and
sixth instructions for transmitting the search results to the computing device.

12. The computer program product of claim 11, wherein the source code search criteria sets forth a functional description of a portion of source code that is desired to be found in the source code of one or more computer programs, wherein the functional description is independent of at least one of variable names and parameter values.

13. The computer program product of claim 11, wherein the source code search criteria parse tree and the source code parse trees are independent of variable names.

14. The computer program product of claim 11, wherein the second instructions for converting the source code search criteria to a parse tree representation include:
instructions for using a partial compiler to interpret the source code search criteria.

15. The computer program product of claim 11, wherein the second instructions for converting the source code search criteria to a parse tree representation include:
instructions for parsing the source code search criteria to identify tokens within the source code search criteria; and
instructions for matching the identified tokens with grammar rules to generate the source code search criteria parse tree representation.

16. The computer program product of claim 11, wherein the fourth instructions for comparing the source code search criteria parse tree representation to the one or more source code parse trees include:
instructions for comparing nodes in the source code search criteria parse tree representation to nodes in the one or more source code parse trees;
instructions for determining if there is a match between at least a portion of the nodes in the source code search criteria parse tree representation and a portion of the nodes in the one or more source code parse trees.

17. The computer program product of claim 16, wherein the fourth instructions for comparing the source code search criteria parse tree representation to the one or more source code parse trees further include:
instructions for determining a degree of matching of nodes in the source code search criteria parse tree representation and the nodes in the one or more source code parse trees.

18. The computer program product of claim 17, wherein the fifth instructions for generating search results based on the comparison of the source code search criteria parse tree representation to the one or more source code parse trees include:
instructions for ranking source code parse trees that have at least a portion of their nodes matching at least a portion of the nodes in the source code search criteria parse tree representation, based on a determined degree of matching of the source code parse trees.

19. The computer program product of claim 11, further comprising seventh instructions for generating the one or more source code parse trees, wherein the seventh instructions include:
instructions for identifying source code to be converted to a source code parse tree;
instructions for parsing the source code to identify tokens within the source code;
instructions for identifying grammar rules applicable to the identified tokens; and
instructions for generating a source code parse tree based on the identified grammar rules as applied to the identified tokens.

20. A system for searching for source code matching search criteria, comprising:
means for receiving, from a computing device, a source code search query identifying source code search criteria;
means for converting the source code search criteria to a parse tree representation;
means for retrieving one or more source code parse trees from a source code parse tree storage;
means for comparing the source code search criteria parse tree representation to the one or more source code parse trees;
means for generating search results based on the comparison of the source code search criteria parse tree representation to the one or more source code parse trees; and
means for transmitting the search results to the computing device.
